(19) United States
(12) Patent Application Publication
(10) Pub. No.: US 2005/0030380 A1
(43) Pub. Date: Feb. 10, 2005

(54) Image providing apparatus, field-of-view changing method, and computer program product for changing field-of-view

(75) Inventor: Ken Oizumi, Tokyo (JP)

Correspondence Address: McDERMOTT, WILL & EMERY, 600 13th Street, N.W., Washington, DC, 20005-3096, US

(73) Assignee: NISSAN MOTOR CO., LTD.

(21) Appl. No.: 10/912,040

(22) Filed: Aug. 6, 2004

(30) Foreign Application Priority Data
Aug. 8, 2003 (JP) P 2003-289610

(51) Int. Cl. H04N 7/18

(52) U.S. Cl. 348/148

(57) ABSTRACT

A vehicular image providing apparatus which includes: an image-taking device which takes an image of a view of an area around a vehicle and generates a first pixelated image thereof; a processing unit which creates a second pixelated image from the first pixelated image; and an image presenting device which presents the second pixelated image. The second pixelated image is different in at least one of direction of line-of-sight and angle-of-view from the first pixelated image. The processing unit creates the second pixelated image, relating each pixel of the first pixelated image to a first two-dimensional variable, setting up a virtual image-taking device providing a virtual image, relating each pixel of the virtual image to a second two-dimensional variable, performing a transformation of variable between the first and second two-dimensional variables.

### BACKGROUND OF THE INVENTION

1. Field of the Invention

The present invention relates to an image providing apparatus, a field-of-view changing method, and a computer program product for changing field-of-view.

2. Description of Related Art

A vehicular monitoring system is disclosed in Japanese Patent Laid-Open Publication No. 2000-177483. The system has cameras provided on both front ends of a vehicle for taking video images of side rear areas and blind spots around the vehicle, and a display for displaying the video images.

### SUMMARY OF THE INVENTION

In order to sufficiently cover the blind spots of the areas around the vehicle in the above mentioned system, it is necessary to install more cameras or to provide each camera with a positioning device for changing camera's line-of-sight or a zoom mechanism for changing camera's angle-of-view, thereby resulting in an increased hardware cost.

The present invention was made in the light of this problem. An object of the present invention is to provide measures for saving hardware cost, including an image providing apparatus, a field-of-view changing method, and a computer program product for changing field-of-view.

An aspect of the present invention is a vehicular image providing apparatus comprising: an image-taking device which takes an image of a view of an area around a vehicle and generates a first pixelated image thereof; a processing unit which creates a second pixelated image from the first pixelated image, the second pixelated image being different in at least one of direction of line-of-sight and angle-of-view from the first pixelated image; and an image presenting device which presents the second pixelated image, wherein the processing unit creates the second pixelated image, relating each pixel of the first pixelated image to a first two-dimensional variable, setting up a virtual image-taking device providing a virtual image, relating each pixel of the virtual image to a second two-dimensional variable, performing a transformation of variable between the first two-dimensional variable and the second two-dimensional variable.

### BRIEF DESCRIPTION OF THE DRAWINGS

The invention will now be described with reference to the accompanying drawings wherein:

FIG. 1A is a top plan view showing a configuration of an image providing apparatus according to an embodiment of the present invention;

FIG. 1B is a side view showing the configuration of the image providing apparatus of FIG. 1.

FIG. 2 is a view for explaining a camera model in the embodiment of the present invention.

FIG. 3 is a view for explaining the camera model in the embodiment of the present invention.

FIG. 4 is a view for explaining a field-of-view changing method in the embodiment of the present invention.

FIG. 5 is a view for explaining the field-of-view changing method in the embodiment of the present invention.

FIG. 6 is a view for explaining the field-of-view changing method in the embodiment of the present invention.

### DETAILED DESCRIPTION OF THE PREFERRED EMBODIMENT

An embodiment of the present invention will be explained below with reference to the drawings, wherein like members are designated by like reference characters.

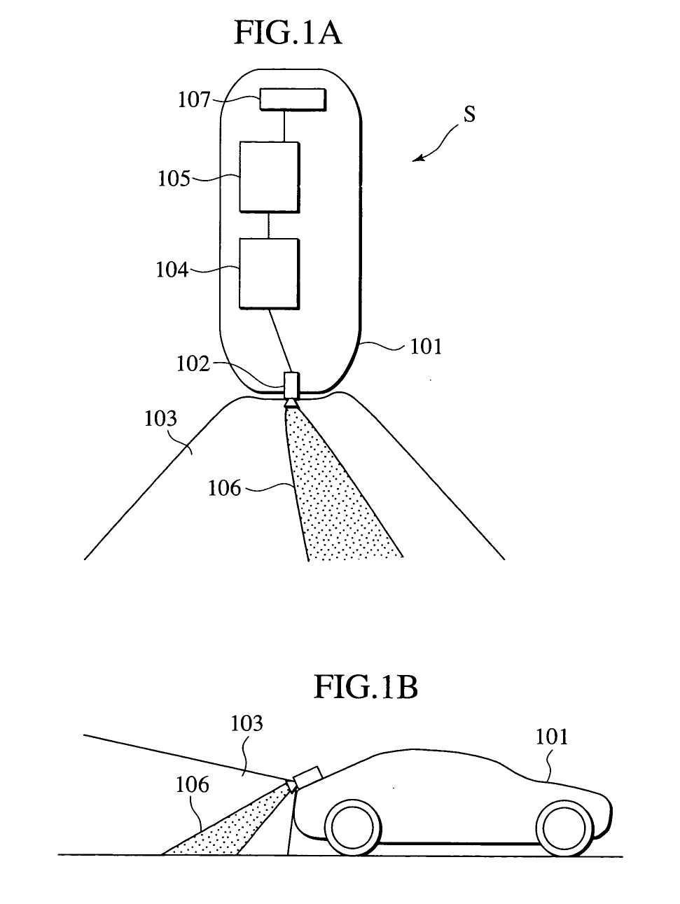

As shown in FIGS. 1A and 1B, an image providing apparatus S of the embodiment includes an electronic camera 102, an image processing unit 104, a field-of-view controller 105, and a display (an image presenting device) 107.

The camera 102 is provided on the rear end of a vehicle 101 and picks up images of a rear-view including a blind spot behind the vehicle 101 to a predetermined extent of a fixed field-of-view 103. The image processing unit 104 captures data of images taken by the camera 102, and processes the data of the images to create a new image to a required extent of field-of-view 106, by a field-of-view changing method to be described later. The display 107 presents images of the processed image data to a driver.

The required field-of-view 106 is a partial field-of-view within the fixed field-of-view 103. Angle-of-view and line-of-sight of the required field-of-view 106 are arbitrarily set by the field-of-view controller 105. The required field-of-view 106 is set to cover an area which gives important information for the driver under various driving conditions, such as the blind spots. The field-of-view controller 105 automatically determines the optimum direction of line-of-sight and angle-of-view of the required field-of-view 106 based on output signals from a switch/button manually operated by the driver or from the other on-vehicle equipments, such as a driving speed, a driving direction, positional information of a GPS device, and the like. The field-of-view controller 105 sends instructions regarding the optimum direction of line-of-sight and angle-of-view of the required field-of-view 106 to the image processing unit 104.

The camera 102 is a tool for providing the driver with expanded information on the area around the vehicle 101, and accordingly, maybe attached onto side faces of the vehicle 101, a front face thereof and the like as appropriate.

The field-of-view changing method according to this embodiment of the present invention will be described below.

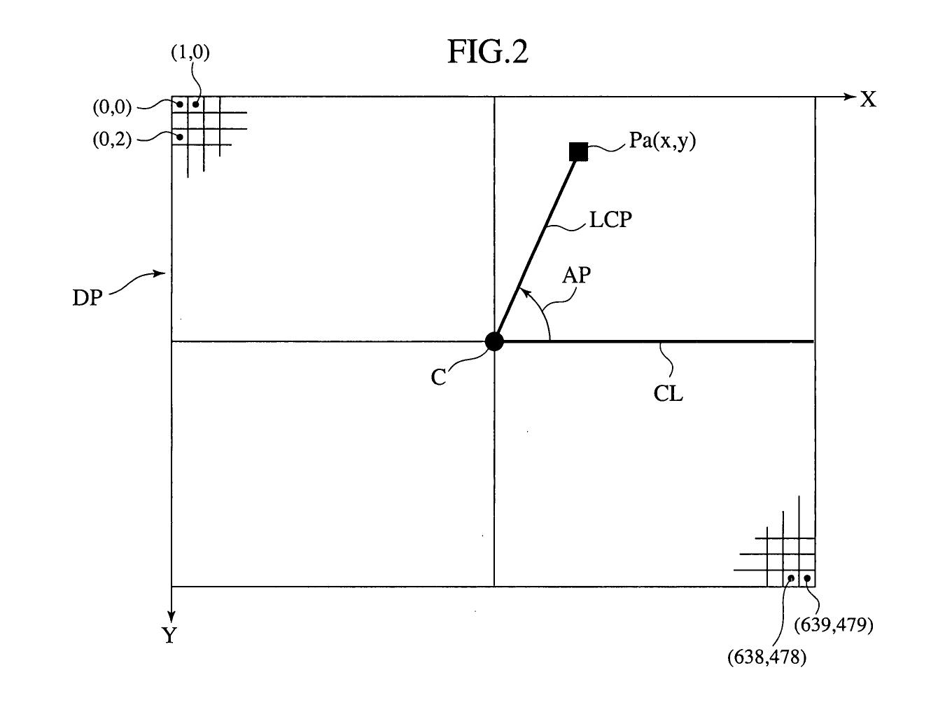

In a camera model in this embodiment, as shown in FIG. 2, a screen image DP outputted from the camera is an aggregate of pixels P. Position of each pixel P is located by a coordinate system commonly used in computer graphics, such as an orthogonal XY coordinate system having 640 pixels laterally and 480 pixels longitudinally, in which the uppermost left pixel position is defined as (0, 0) and the lowermost right pixel position is defined as (639, 479).

A center point C of the screen DP is defined as a reference point, and a line CL extended from the point C in an upper right direction of FIG. 2 is defined as a reference line. A position (x, y) of a certain pixel Pa is located by the polar coordinate with the point C and the reference line CL, as (LCP, AP) wherein LCP represents a length of a line segment C-P and AP represents an angle formed between the line segment C-P and the reference line CL. The length LCP always takes a positive value, and the angle AP in a direction counterclockwise from the reference line CL in FIG. 2 is defined as a positive angle.

A relationship between (x, y) and (LCP, AP) can be represented as follows.
x=LCP×cos(AP)+(W/2) (fractional portion is dropped) (1)
y=LCP×sin(AP)+(H/2) (fractional portion is dropped) (2)
LCP=[(x−W/2+0.5)²+(y−H/2+0.5)²]^{1/2} (3)
AP=arccos[(x−W/2+0.5)/LCP] (when y<H/2) (4.1)
AP=arccos[(x−W/2+0.5)/LCP]+,, (when y≧H/2) (4.2)
where W represents the number of pixels in the lateral direction of the screen DP, and H represents the number of pixels in the longitudinal direction of the screen DP. x and y are integers within ranges of 0≦x≦639 and 0≦y≦479, respectively.

The expressions (1), (2), (3), (4.1) and (4.2) can be represented as:
(LCP, AP)=Fs(x, y) (5)
(x, y)=Fsi(LCP, AP) (6)
where the function Fsi (u) is an inverse function of the function Fs (u).

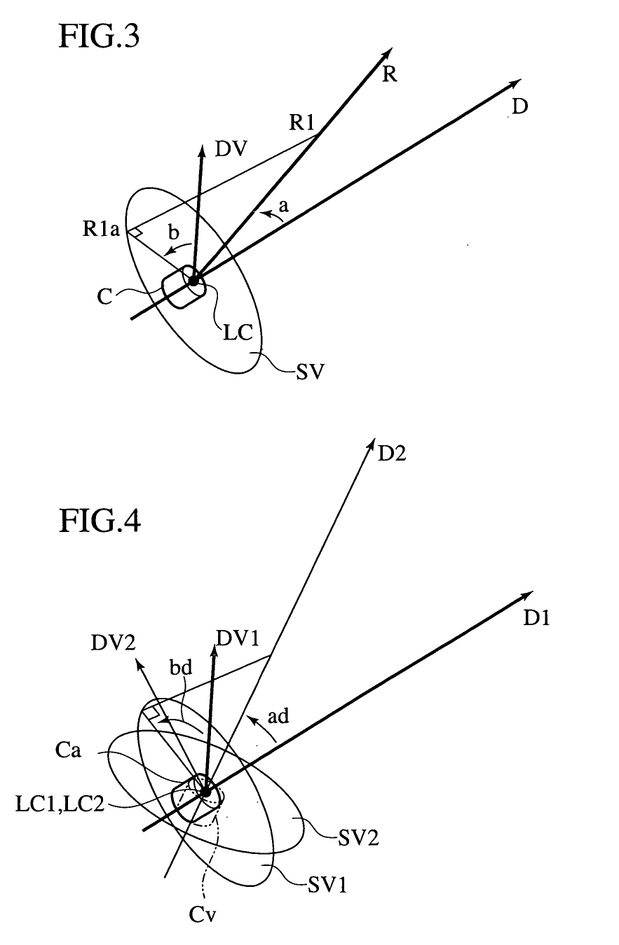

Now, as shown in FIG. 3, it is assumed that a camera C is positioned on an arbitrary point LC in a space and tilted to have its line-of-sight in a direction D. A plane SV has the point LC therein and is orthogonal to the direction D, and a predetermined direction DV orthogonal to the direction D lies on the plane SV. The plane SV is a boundlessly extending plane though being illustrated in a disc shape with a diameter in FIG. 3.

Here, a direction R represents a direction of an incident light to the camera C radiated from an object in the field-of-view of the camera C, or a direction pointing to the position of the object. With the directions D and DV taken as references, the direction R is defined by an angle “a” formed by the direction D and the direction R and an angle “b” formed by the direction DV and a projection of the direction R on the plane SV. Specifically, the direction R is defined two-dimensionally with respect to the direction D of the camera C. In FIG. 3, the angle “b” is an angle formed by the direction DV and a line segment connecting the point LC and an intersection point R1a. The intersection point R1a is an intersection point where a line parallel to the direction D passing through a point R1 in the direction R, intersects with the plane SV.

A relationship between the direction R (a, b) of the incident light and the position of each pixel of the camera C, arranged as shown in FIG. 2, can be conceptually defined by the following expressions.
LCP=f(a) (7)
AP=b+constant (8)

Where, f (u) is a function of an independent variable “u”. By properly setting the function, lens characteristics (distortion and angle of view of a lens) of the camera C can be easily simulated. For example, for a lens with ideal characteristics, the function can be set as:
f(u)=k×a(k: constant) (9)
In the case of simulating a pinhole camera, the function can be set as:
f(u)=k×tan(a)(k: constant) (10)

The function f (u) may also be determined based on measurement data of the actual lens characteristics.

The direction R (a, b) corresponding to each pixel P of the camera C is determined by the expressions (7) and (8). Accordingly, in the camera C with its line-of-sight in the direction D, if the relationship between the direction D and the direction R is defined, image data on each pixel P of the camera C can be obtained.

In this embodiment, the expression (9) is used for the function f (u), and the length LCP is obtained as:
LCP=k×a(k: constant) (11)
Adjustment of the camera's angle-of-view is reproduced by changing the constant k.

The relationships of the expression (11) and the expression (8) are represented in combination as the following functions F (u).
(LCP, AP)=F(a, b) (12)
(a, b)=Fi(LCP, AP) (13)
where the function Fi (u) is an inverse function of the function F (u).

Relationship between the direction R(a, b) of the incident light to the camera C which is positioned and tilted to have its line-of-sight in the direction D, and the position of each pixels P of the camera C is represented by the following expressions based on the expressions (5), (6), (12) and (13).
(x, y)=Fsi[F(a, b)] (14)
(a, b)=Fi[Fs(x, y)] (15)
where the incident light in the direction R(a, b) means color information.

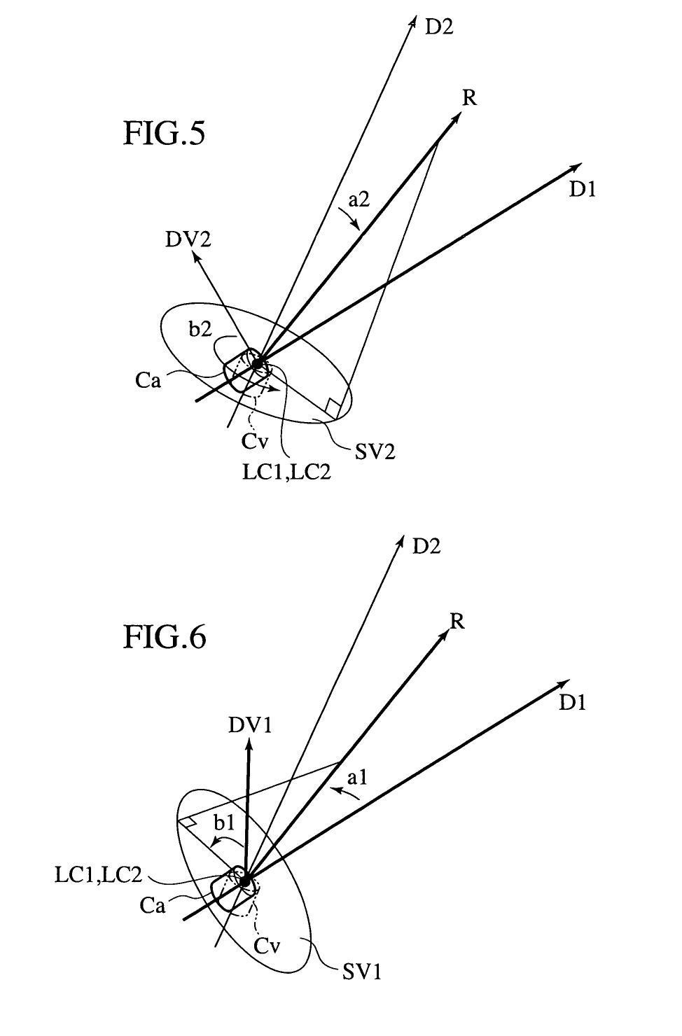

Next, the field-of-view changing method using the above-described camera model will be described with reference to FIGS. 4 to 6.

Now, two camera models are assumed, which are: a camera model 1 corresponding to an actual camera Ca; and a camera model 2 corresponding to a virtual camera Cv which is set up and provides image data with the changed field-of-view. Positions of the cameras Ca and Cv are respectively denoted as LC1 and LC2 as shown in FIG. 4. Directions of the camera's line-of-sights and the other definitions or functions are similarly designated, using reference numbers “1” or “2” for each camera model. It is assumed that each of the relational expressions Fs (u), Fsi (u), F (u) and Fi (u) of each camera model is properly set. The functions of the camera model 1 are represented as Fs1 (u), Fsi1 (u), F1 (u) and Fi1 (u), and the functions of the camera model 2 are represented as Fs2 (u), Fsi2 (u), F2 (u) and Fi2 (u).

The virtual camera Cv is located in the same position as that of the actual camera Ca (LC1=LC2), tilted to have its line-of-sight in a direction D2, and takes image of a partial region within the field-of-view of the actual camera Ca.

In the camera model 2, the direction R of the incident light, which corresponds to a pixel P2 (x2, y2) thereof, is represented by the following expression (16) based on the expression (15) with the direction D2 and a direction DV2 taken as references.
(a2, b2)=Fi2[Fs2(x2, y2)] (16)

Meanwhile, the direction D2 is defined by (ad, bd) with directions D1 and DV1 of the actual camera Ca taken as references as shown in FIG. 3. Accordingly, the direction R is represented by the following expression (17) using a predetermined transformation function Ft with directions D1 and DV1 of the camera model 1 taken as references.
(a1, b1)=Ft[(ad, bd), (a2, b2)] (17)
Note that the direction DV2 is a direction to be uniquely defined if the direction D2 is defined. The direction DV2 may be the one in a plane including the direction D2 and a vertical axis passing through the position LC2.

Moreover, in the camera model 1, a pixel P1 (x1, y1) corresponding to the direction R is represented by the following expression (18) based on the expression (14).
(x1, y1)=Fsi1[F1(a1, b1)] (18)

Based on the expressions (16), (17) and (18), the following expression (19) is established.
(x1, y1)=Fsi1[F1(Ft((ad, bd), Fi2(Fs2(x2, y2))))] (19)

From this expression, a correspondence of the pixel P2 (x2, y2) of the virtual camera Cv to the pixel P1 (x1, y1) of the actual camera Ca is obtained. Specifically, image data of virtual images of the virtual camera Cv can be obtained from the image data of the pixels P1 of the actual camera Ca, by performing the calculation of the expression (19) on the entire pixels P2 of the virtual camera Cv.

Even in the case that a wide-angle camera is used as the actual camera Ca, an image distortion attributable to a wide-angle lens thereof can be corrected by using the above-described camera models in processing the image data of the actual camera Ca to provide the virtual images of the virtual camera Cv.

Table of functions “cosine”, “sine” and “arc cosine” can be used for easier calculations, which is performed by arithmetic operations on the numerical values in the table. Input values and output values of the functions of cosine, sine and arc cosine are limited in a range. Accordingly, utilization of the table is a realistic solution to perform calculations of these functions by means of simply constructed hardware and CPU.

Note that the actual camera Ca in the above description is the camera 102 in FIG. 1 and the virtual camera Cv is another camera taking images of an area in the required field-of-view 106. By using this method, images of the partial area within field-of-view of the camera 102 can be formed as if the images were taken by the other camera with arbitrarily adjustable line-of-sight and field-of-view.

The images formed in the above-described method are presented to the driver through the display 107. The driver is thus provided with effective information for making judgments under various driving conditions, which is extracted from the field-of-view 103 of the camera 102, thus reducing a driver's workload.

As described above, the image providing apparatus of this embodiment includes the camera 102 that is the image-taking device taking rear-view images of the area around the vehicle 101, the image processing unit 104 which processes the images taken by the camera 102, and the display 107 which displays the images processed by the image processing unit 104. The image processing unit 104 has the following configuration. Each pixel of the image (actual image) taken by the camera 102 is related to the first two-dimensional variable, and each pixel of the virtual image taken by the virtual image-taking device is related to the second two-dimensional variable. Then, a transformation of variables is performed between the first two-dimensional variable and the second two-dimensional variable, and the processed image is formed which at least one of the direction of line-of-sight and angle-of-view thereof is changed.

Moreover, the field-of-view changing method of this embodiment has the following configuration. Each pixel of the image taken by the camera 102 which takes an image of the view of the area around the vehicle 101 is related to the first two-dimensional variable, and each pixel on the virtual image formed by the image-taking device that is virtually set is related to the second two-dimensional variable. Then, the transformation of variables is performed between the first two-dimensional variable and the second two-dimensional variable, and the processed image in which at least one of the direction of line-of-sight and range is changed is formed.

Furthermore, a computer program product for changing field-of-view has the following configuration which is realized by a computer. Each pixel of the image of the view of the area around the vehicle, taken by the image-taking device, is related to the first two-dimensional variable, and each pixel on the virtual image formed by the set up virtual image-taking device is related to the second two-dimensional variable. Then, the transformation of variables is performed between the first two-dimensional variable and the second two-dimensional variable, and the processed image in which at least one of the direction of line-of-sight and range is changed is formed.

With such configurations, images which provide the driver with effective information in making judgments under various driving conditions, can be acquired without rotating/tilting the camera 102 attached on the vehicle 101, and only the image information necessary for the driver is presented. Heretofore, in order to provide images of the area around the vehicle 101 at necessary and sufficient field-of-view, it has been necessary to install more cameras or to provide each camera with a positioning device for changing camera's line-of-sight or a zoom mechanism for changing camera's angle-of-view. Thus, hardware cost has been increased, and an appearance of the vehicle exterior has been deteriorated. Meanwhile, in this embodiment, the number of cameras 102 can be one, for example. In addition, it is unnecessary to provide a positioning device for changing the line-of-sight of the camera 102 or a zoom mechanism for changing the angle-of-view, thus saving the hardware cost and enhancing the vehicle appearance. Moreover, the images to be displayed can be obtained by less numbers of calculations, and accordingly, the hardware cost is saved. In the case that a partial image of an image taken by a wide-angle camera is presented without being processed, the partial image becomes distorted. In this embodiment, even in the case of creating images to be presented from the images taken by the wide-angle camera, distortion of the images can be eliminated, thus enhancing the driver's situational awareness.

Moreover, in the image processing unit of the embodiment, each pixel is related to the two-dimensional angular variable, whereby the number of calculations is reduced, and the hardware cost is saved.

The preferred embodiment described herein is illustrative and not restrictive, and the invention may be practiced or embodied in other ways without departing from the spirit or essential character thereof. The scope of the invention being indicated by the claims, and all variations which come within the meaning of claims are intended to be embraced herein.

The present disclosure relates to subject matters contained in Japanese Patent Application No. 2003-289610, filed on Aug. 8, 2003, the disclosure of which is expressly incorporated herein by reference in its entirety.

1. A vehicular image providing apparatus comprising:
an image-taking device which takes an image of a view of an area around a vehicle and generates a first pixelated image thereof;
a processing unit which creates a second pixelated image from the first pixelated image, the second pixelated image being different in at least one of direction of line-of-sight and angle-of-view from the first pixelated image; and
an image presenting device which presents the second pixelated image, wherein
the processing unit creates the second pixelated image, relating each pixel of the first pixelated image to a first two-dimensional variable, setting up a virtual image-taking device providing a virtual image, relating each pixel of the virtual image to a second two-dimensional variable, performing a transformation of variable between the first two-dimensional variable and the second two-dimensional variable.

2. The image providing apparatus according to claim 1, wherein
one of the first and second two-dimensional variables comprises two angular variables.

3. A field-of-view changing method comprising:
generating a first pixelated image of a view of an area around a vehicle; and
creating from the first pixelated image, a second pixelated image which is different in at least one of direction of line-of-sight and angle-of-view from the first pixelated image, relating each pixel of the first pixelated image to a first two-dimensional variable, setting up a virtual image-taking device providing a virtual image, relating each pixel of the virtual image to a second two-dimensional variable, performing a transformation of variables between the first two-dimensional variable and the second two-dimensional variable.

4. A computer program product for use in a computer which creates, from a first pixelated image of a view of an area around a vehicle generated by an image-taking device, a second pixelated image which is different in at least one of direction of line-of-sight and angle-of-view from the first pixelated image, relating each pixel of the first pixelated image to a first two-dimensional variable, setting up a virtual image-taking device providing a virtual image, relating each pixel of the virtual image to a second two-dimensional variable, performing a transformation of variables between the first two-dimensional variable and the second two-dimensional variable.

5. A vehicular image providing apparatus comprising:
means for taking an image of a view of an area around a vehicle and generating a first pixelated image thereof;
means for creating a second pixelated image from the first pixelated image, the second pixelated image being different in at least one of direction of line-of-sight and angle-of-view from the first pixelated image; and
means for presenting the second pixelated image, wherein
the means for creating the second pixelated image creates the second pixelated image, relating each pixel of the first pixelated image to a first two-dimensional variable, setting up a virtual image-taking device providing a virtual image, relating each pixel of the virtual image to a second two-dimensional variable, performing a transformation of variable between the first two-dimensional variable and the second two-dimensional variable.
